(19) United States
(12) Patent Application Publication
(10) Pub. No.: US 2019/0158701 A1
(43) Pub. Date: May 23, 2019

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Takafumi TERADA, Sunto Shizuoka (JP)

(21) Appl. No.: 15/819,258

(22) Filed: Nov. 21, 2017

(51) Int. Cl. H04N 1/409; H04N 1/405; H04N 1/52; H04N 1/00

(52) U.S. Cl. CPC H04N 1/4092; H04N 1/405; H04N 2201/0094; H04N 1/00806; H04N 1/52

(57) ABSTRACT

According to one embodiment, an image forming apparatus includes a printer configured to form an image on a sheet according to image data supplied to the printer, a first storage device that stores image data of a predetermined test pattern image, an image reading unit configured to read the image formed on the sheet, a second storage device that stores a gamma correction table, the gamma correction table specifying a maximum output density of the printer, the maximum output density being determined according to a maximum read density that has been read from a sheet on which the predetermined test pattern image has been formed by the printer, and a controller configured to apply a gamma correction to a pixel of the image data or not in accordance with the gamma correction table according to whether or not the pixel represents an edge portion of the image.

### FIELD

Embodiments described herein relate generally to an image forming apparatus and an image forming method.

### BACKGROUND

In the related art, for the purpose of keeping gradation reproduction constant in a multifunctional printer (MFP), gradation correction control is generally performed. In gradation correction control, correction of solid density is performed by image quality maintenance control, and then correction of halftone density is performed by gamma control. In image quality maintenance control, the solid density is corrected using a sensor that reads a pattern printed on a transfer belt and an image forming condition, such as developing bias, is adjusted in accordance with the sensor read value. In gamma control, a gradation pattern printed on paper is scanned, a comparison result of the scanned gradation pattern with intended characteristics of the pattern is recorded in a correction table, and halftone density is then corrected based on the correction table.

The method of correcting solid density by image quality maintenance control and correcting halftone by gamma control as described above has been generally used. A pixel value of a solid pattern (also referred to as solid density) is decreased by the gamma control, and thus it is also possible to correct solid density with gamma control in some instances. However, if solid density can only be decreased by gamma control, the solid density cannot be increased when necessary. Thus, correction to increase the solid density is not possible via gamma control. The technology of decreasing the solid density by the gamma control has been effectively applied, for example, to a case where sufficient correction of solid density by image quality maintenance control is not possible due to deterioration of a necessary component over time, when solid density is more than an expected value, or when the image quality maintenance control function is not provided at all as in a lower cost device.

However, in this technology, when the pixel value of solid is only decreased, thin lines, fine characters, or the like may eventually have to be converted to halftone data rather than solids. Thus, screening occurs, and thereby image quality may be deteriorated. For example, interruption or pixilation at an edge may occur.

### DESCRIPTION OF THE DRAWINGS

FIG. 1 is an external view of an image forming apparatus according to an embodiment.

FIG. 2 is a functional block diagram of an image forming apparatus according to the embodiment.

FIG. 3 is a diagram of an example of a test image.

FIG. 4 is a diagram of an example of a gamma correction table.

FIG. 5 is a diagram of a gradation characteristic of a test image that has been read.

FIG. 6 is a diagram of a gamma correction table when the gradation characteristic in FIG. 5 is obtained.

FIG. 7 is a flowchart of processing of an image forming apparatus according to the embodiment.

FIG. 8 is a flowchart of gamma correction processing of an image forming apparatus according to the embodiment.

FIG. 9 is a diagram of an input image before a gamma correction processing.

FIG. 10 is a diagram of a result after a gamma correction processing.

FIG. 11 is a diagram of a result after a halftone processing.

FIG. 12 is a diagram of edge information according to the embodiment.

FIG. 13 is a diagram of a result after a gamma correction processing based on edge information according to the embodiment.

FIG. 14 is a diagram of a result after a halftone processing according to the embodiment.

### DETAILED DESCRIPTION

In general, according to one embodiment, an image forming apparatus includes a printer configured to form an image on a sheet according to image data supplied to the printer, a first storage device that stores image data of a predetermined test pattern image, an image reading unit configured to read the image formed on the sheet, a second storage device that stores a gamma correction table, the gamma correction table specifying a maximum output density of the printer, the maximum output density being determined according to a maximum read density that has been read from a sheet on which the predetermined test pattern image has been formed by the printer, and a controller configured to apply a gamma correction to a pixel of the image data or not in accordance with the gamma correction table according to whether or not the pixel represents an edge portion of the image.

Hereinafter, an image forming apparatus and an image forming method according to an embodiment will be described with reference to the drawings.

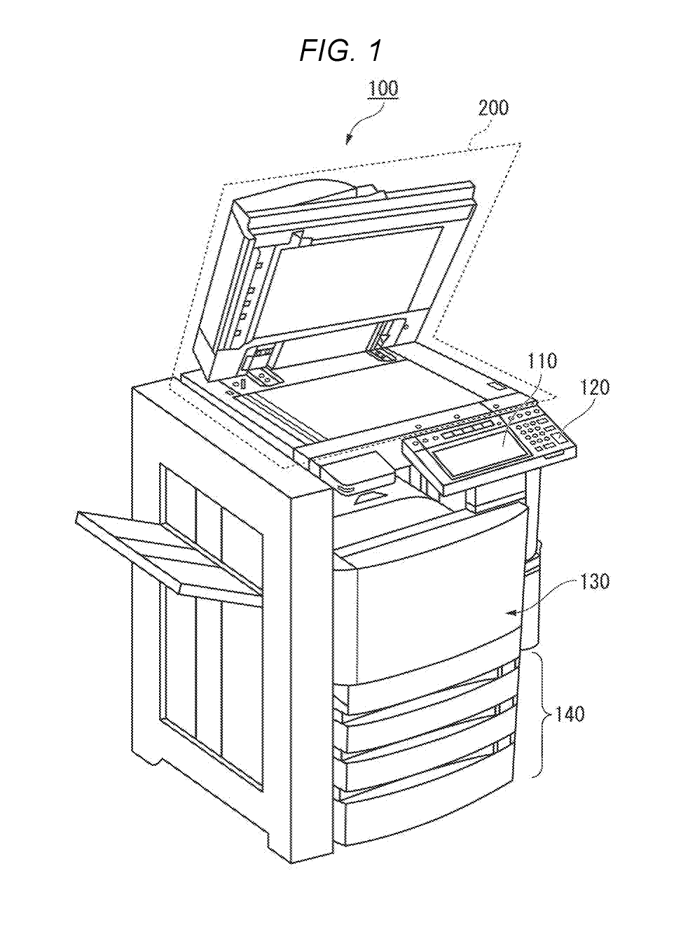

FIG. 1 is an external view of an image forming apparatus 100 according to the embodiment. The image forming apparatus 100 is an image forming apparatus such as a multifunctional machine. The image forming apparatus 100 includes a display 110, a control panel 120, a printer unit 130, a sheet accommodation unit 140, and an image reading unit 200. The printer unit 130 in the image forming apparatus 100 may be a device that fixes a toner image or may be an ink jet type device.

The image forming apparatus 100 reads an image printed on a sheet so as to generate digital data and to generate an image file. The sheet may be, for example, any document or paper on which a character, an image, or the like is printed. The sheet may be any material so long as the sheet can be read by the image forming apparatus 100.

The display 110 is an image display device such as a liquid crystal display or an organic electroluminescence (EL) display. The display 110 displays various types of information regarding the image forming apparatus 100.

The control panel 120 includes a plurality of buttons. The control panel 120 receives instructions from a user via the buttons. The control panel 120 outputs a signal depending on an instruction from a user, to a control unit of the image forming apparatus 100. The display 110 and the control panel 120 may be integrated and configured as a touch panel.

The printer unit 130 outputs an image onto a sheet so as to form an image on the sheet. The printer unit 130 outputs the image based on image information generated by the image reading unit 200 or image information received via a communication channel. The printer unit 130 forms an image, for example, by the following processing. An image forming unit of the printer unit 130 forms an electrostatic latent image on a photoconductive drum based on the image information. The image forming unit of the printer unit 130 forms a visible image by adhering a developer to the electrostatic latent image. The developer may be, for example, a toner. A transfer unit of the printer unit 130 transfers the visible image onto a sheet. A fixing unit of the printer unit 130 fixes the visible image on the sheet by heating and pressing the sheet. The sheet on which an image is formed may be a sheet accommodated in the sheet accommodation unit 140 or may be a sheet which is manually fed to the printer unit 130.

The sheet accommodation unit 140 accommodates sheets to be used by the printer unit 130.

The image reading unit 200 reads an image from a sheet by reading image information such as brightness and the darkness of light reflected from the reading target. The image reading unit 200 records the image information which has been read. The recorded image information may be transmitted to another information processing apparatus through a network. An image corresponding to the recorded image information may be formed on a sheet by the printer unit 130.

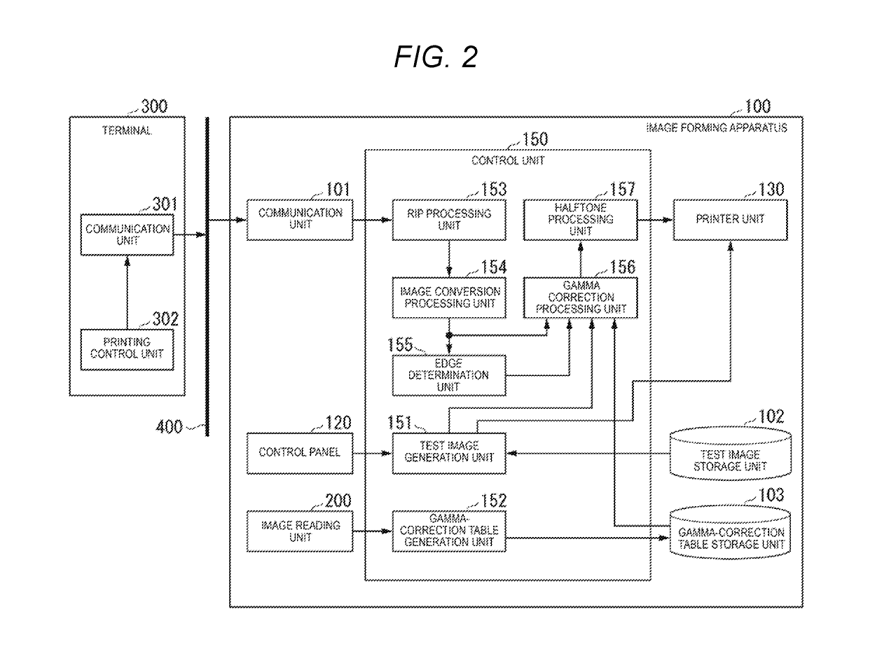

FIG. 2 is a functional block diagram of the image forming apparatus 100 according to the embodiment. The image forming apparatus 100 and a terminal 300 are connected to each other so as to enable a communication with each other through a network 400. Any network may be constructed as the network 400. For example, the network 400 may be constructed as a local area network (LAN).

The image forming apparatus 100 includes a communication unit 101, a test image storage unit 102, also referred to as a first storage device, a gamma-correction table storage unit 103, also referred to as a second storage device, the control panel 120, the printer unit 130, a control unit 150, and the image reading unit 200.

The communication unit 101 is a network interface. The communication unit 101 communicates with the terminal 300 through the network 400. The communication unit 101 may perform communication in accordance with a communication scheme such as a local area network (LAN) or Bluetooth®, for example.

The test image storage unit 102 is configured by a storage device such as a magnetic hard disk drive or a semiconductor storage device. The test image storage unit 102 stores a test image data. A test image is an image in which gradation patch images which respectively show gradation of colors of CMYK are arranged in a main scanning direction. The gradation patch image is an image for adjusting the amount of the developer adhered to the sheet. The test image data is stored in the test image storage unit 102 in advance.

The gamma-correction table storage unit 103 includes or has access to a storage device such as a magnetic hard disk or a semiconductor storage device. The gamma-correction table storage unit 103 stores a gamma correction table in the storage device. The gamma correction table is a table in which an input value (read value) of a pixel is associated with an output value, which is a value obtained by correcting the input value. The gamma correction table includes a maximum output value corresponding to a maximum read density. The gamma correction table is generated by the gamma-correction table generation unit 152. The gamma correction table is generated for each of the colors of CMYK (cyan, magenta, yellow, black).

The control unit 150 controls an operation of each of the units in the image forming apparatus 100. The control unit 150 is, for example, a device which includes a central processing unit (CPU) and a random access memory (RAM). The control unit 150 executes an image forming program so as to function as a test image generation unit 151, a gamma-correction table generation unit 152, a RIP processing unit 153, an image conversion processing unit 154, an edge determination unit 155, a gamma correction processing unit 156, and a halftone processing unit 157.

The test image generation unit 151 acquires the test image data stored in the test image storage unit 102. The test image generation unit 151 transmits the acquired test image to the printer unit 130, and thus a test image is formed on a sheet.

The gamma-correction table generation unit 152 generates the gamma correction table based on the test image read by the image reading unit 200. The gamma-correction table generation unit 152 determines an output value regarding exposure to the photoconductive drum, based on an input value. Here, the input value refers to read density at a pixel of the image data. The output value refers to output density corresponding to a density at the pixel of the image data. A potential of an electrostatic latent image to be formed on the photoconductive drum is determined in accordance with the output value regarding the exposure. The amount of a toner adhering to a sheet is adjusted in accordance with the potential. Solid density is determined in accordance with the amount of the toner adhered to the sheet. A method of causing the gamma-correction table generation unit 152 to determine the output value will be described later in detail.

The RIP processing unit 153 converts a print job received from the terminal 300 into image data in a raster format. The raster format refers to an image format in which information of a color and density is recorded in pixel units. The RIP processing unit 153 generates attribute information from the image data. The attribute information refers to image information included in the image data. For example, the attribute information refers to an image such as a picture, a vector graphic, a text representing a character string, or the like. The RIP processing unit 153 outputs the image data and the attribute information to the image conversion processing unit 154. The print job refers to an image forming command which is assigned to the image forming apparatus 100. The print job includes image data to be used for forming the image on a sheet.

The image conversion processing unit 154 performs color conversion and filtering on the image data received from the RIP processing unit 153. The color conversion refers to reproduction of image data with improved gradation, for example. The filtering is performed, for example, by a smoothing filter or a Gaussian filter. The color conversion and the filtering may be performed by any known method. The image conversion processing unit 154 outputs image data to the edge determination unit 155 and the gamma correction processing unit 156.

The edge determination unit 155 determines whether or not a pixel of the received image data represents an edge portion. The edge determination unit 155 performs a filter operation on each pixel by using an edge detection filter. The edge determination unit 155 determines whether a pixel is an edge pixel or a non-edge pixel, based on a result of the filter operation. The edge determination unit 155 generates edge information based on an edge determination result. Here, the edge information refers to information indicating whether or not a pixel represents an edge portion. The edge determination unit 155 outputs the generated edge information to the gamma correction processing unit 156. The edge detection filter is a Laplacian filter, for example. The edge detection filter may be any other filter that can determine whether a pixel is an edge pixel or a non-edge pixel.

When pixels included in image data represent a thin line, the edge determination unit 155 determines that the pixels are edge pixels. When pixels aligned in a direction orthogonal to a length of a line of pixels satisfy a predetermined condition, the edge determination unit 155 determines that the pixels represent a thin line. The predetermined condition may be that a difference of read density between two pixels aligned in the direction orthogonal to the length is within a predetermined range.

The gamma correction processing unit 156 determines whether or not gamma correction processing is performed on each pixel of image data in accordance with the gamma correction table, which maps an input value of a pixel to a targeted value. The determination is performed based on the received edge information. The gamma correction processing unit 156 acquires edge information of a target pixel from the edge determination unit 155. The gamma correction processing unit 156 reads density of the image data acquired from the image conversion processing unit 154. The gamma correction processing unit 156 reads the gamma correction table from the gamma-correction table storage unit 103. The gamma correction processing unit 156 may store the gamma correction table. When the gamma correction processing unit 156 stores the gamma correction table, the image forming apparatus 100 may not include the gamma-correction table storage unit 103.

When an input value (also referred to as read density) of a target pixel in the image data acquired from the image conversion processing unit 154 does not equal the maximum output value in the gamma-correction table, the gamma correction processing unit 156 sets a value obtained by performing gamma correction processing on the input value to be an output value for the target pixel. That is, when the read density of a pixel of the acquired image data does not equal the maximum output value in the gamma-correction table, the gamma correction processing unit 156 determines that an output value of the pixel is a corrected value.

When an input value (also referred to as read density) of a target pixel in the acquired image data equals the maximum output value in the gamma-correction table and the edge information indicates the target pixel is a non-edge pixel, the gamma correction processing unit 156 sets a value obtained by performing gamma correction processing on the input value to be an output value for the target pixel. That is, when the read density of a pixel in the acquired image data equals the maximum output value and the edge information indicates that the pixel does not represent an edge portion, the gamma correction processing unit 156 determines that an output value of the pixel is a corrected value.

When an input value (also referred to as read density) of a target pixel of the acquired image data equals the maximum output value in the gamma-correction table and the edge information indicates the target pixel is an edge pixel, the gamma correction processing unit 156 sets the input value itself to be an output value. That is, when the read density of the pixel in the acquired image data equals the maximum output value and the edge information indicates that the pixel represents an edge portion, the gamma correction processing unit 156 determines that an output value of the pixel is not corrected.

The gamma correction processing unit may set a value approximate to an input value to be an output value of an edge pixel. The approximate value may be, for example, a value which is greater than the input value by 1. The target pixel is a pixel as a target of determining whether or not the gamma correction processing is performed.

The gamma correction processing refers to processing of correcting the input value based on the gamma correction table. Here, the input value after correction is equal to the output value of the gamma correction table. The gamma correction processing unit 156 determines the output value of the gamma correction table, based on the input value. The gamma correction processing unit 156 outputs the determined output value to the halftone processing unit 157.

The halftone processing unit 157 converts image data corrected by the gamma correction processing into image data which is usable for printing by the printer unit 130. The halftone processing unit 157 combines pixel values of a plurality of pixels having predetermined gradation to produce multi-tone gradation. The halftone processing unit 157 converts image data, for example, by using an error diffusion method, a dithering method, or a density pattern method.

The terminal 300 is configured by an information processing apparatus such as a mainframe, a workstation, or a personal computer. The terminal 300 includes a CPU, a memory, an auxiliary storage device, and the like which are connected to each other by a bus. The terminal 300 executes a print data generation program so as to function as a device which includes a communication unit 301 and a printing control unit 302. All or some of the functions of the terminal 300 may be performed by using hardware such as an ASIC, a PLD, and an FPGA. The print data generation program may be recorded in a computer-readable recording medium. Examples of the computer-readable recording medium include a portable medium such as a flexible disk, a magneto-optical disk, a ROM, a CD-ROM, and a semiconductor storage device (for example, an SSD) and a storage device such as a hard disk or a semiconductor storage device, which is mounted in a computer system.

The communication unit 301 is a network interface. The communication unit 301 communicates with the image forming apparatus 100. The communication unit 301 may perform communication in accordance with a communication scheme such as a LAN or Bluetooth, for example. The printing control unit 302 transmits a print job to the image forming apparatus 100 through the communication unit 301, in accordance with an operation of a user. The printing control unit 302 is, for example, a printer driver.

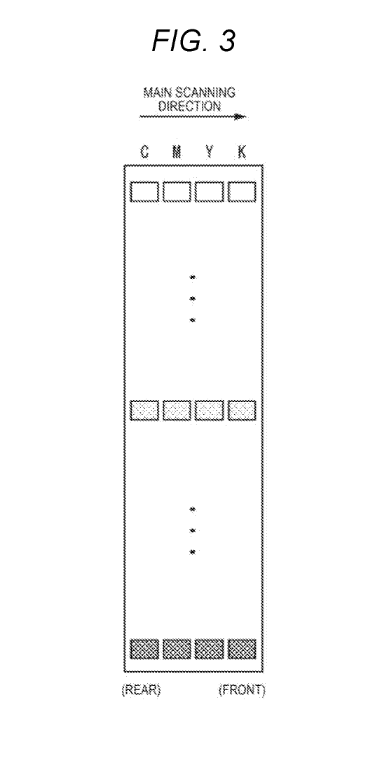

FIG. 3 is a diagram illustrating an example of the test image. The test image has a pattern in which halftone and solid patches of each of the colors of CMYK are arranged. The patches have pixel values increasing in a sub-scanning direction orthogonal to the main scanning direction. Here, a solid patch refers to a group of pixels having a pixel value of the maximum output value. That is, an image arranged in the test image includes a patch in which the pixel values are the maximum output value. The maximum output value of a pixel value is, for example, 255.

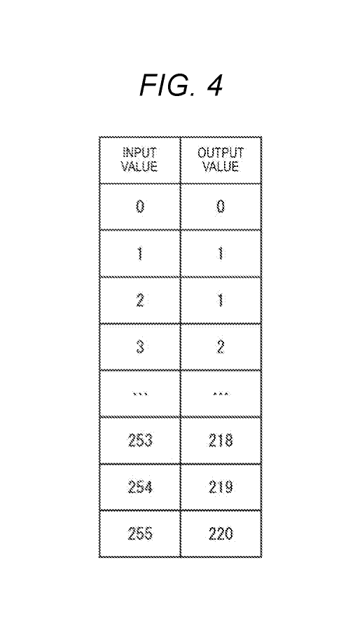

FIG. 4 is a diagram illustrating an example of the gamma correction table. The gamma correction table includes gamma correction records. The gamma correction record includes values of an input value and an output value corresponding to the input value. The input value indicates read density of input image data of the gamma correction processing unit 156. The output value indicates output density of the image data in the gamma correction processing unit 156 when the gamma correction processing unit 156 performs the gamma correction processing on the input value. The solid density indicates density of a color in a state where the toner adheres to a sheet. The gamma correction table is generated for each of the colors of CMYK.

In the example illustrated in FIG. 4, the top record in the gamma correction table has “0” as the input value and “0” as the output value. Thus, according to the top record in the gamma correction table, when all input values of the image data which is read are 0, an image is formed to have output values of which all are set to be 0. In the example illustrated in FIG. 4, the bottom record in the gamma correction table has “255” as the input value and “220” as the output value. Thus, according to the bottom record in the gamma correction table, when all input values of the image data which is read are 255, an image is formed to have output values of which all are set to be 220.

The gamma correction table illustrated in FIG. 4 is just one example. The gamma correction table may be configured to have a form which is different from that in FIG. 4. For example, the gamma correction table may show all colors of CMYK in one table.

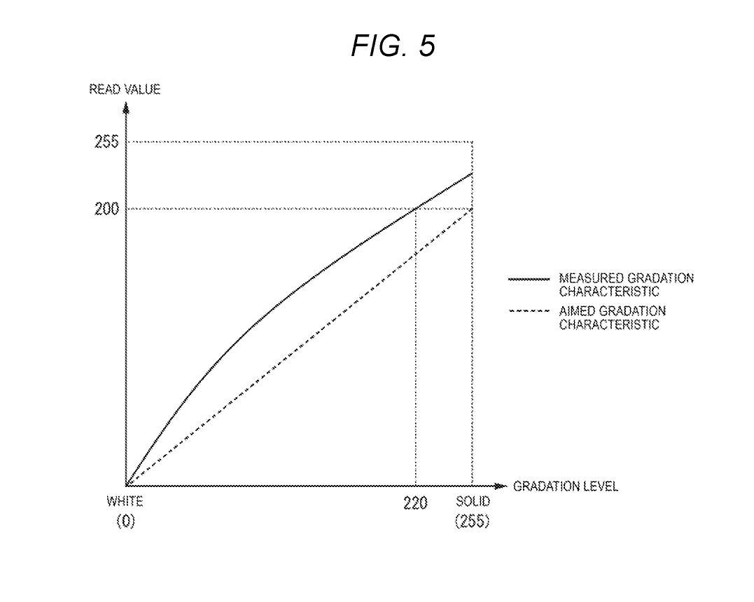

FIG. 5 is a diagram of gradation characteristic of the test image as read. A vertical axis indicates a read value obtained when the test image is read by the image reading unit 200. The gamma-correction table generation unit 152 calculates the gamma correction table based on the read value. The gamma-correction table generation unit 152 generates the gamma correction table based on the maximum read density of the test image, when the image reading unit 200 reads an image output by the printer unit 130 based on test image data. The gamma-correction table generation unit 152 determines the read value of solid for the targeted gradation characteristic, so as to match with desired output density. In the example illustrated in FIG. 5, when the targeted read value of solid is set to be 200 and corresponding gradation level is set to be 255, a gradation level corresponding to the measured read value of 200 is set to be 220. In this case, the gamma-correction table generation unit 152 sets the gradation level to be 220 in the gamma correction table (FIG. 4). That is, a targeted value in the gamma correction table, which corresponds to an output value of a pixel, is smaller than a read value obtained by reading the test image. The maximum output density of the printer unit 130 is set in the gamma correction table. The gamma-correction table generation unit 152 performs a similar computation at all gradation levels, so as to generate the gamma correction table.

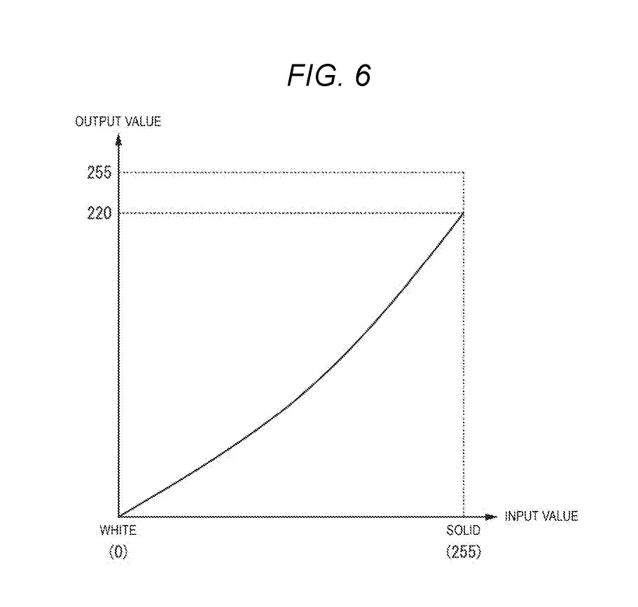

FIG. 6 is a diagram of the gamma correction table when the gradation characteristic in FIG. 5 is obtained, according to the embodiment.

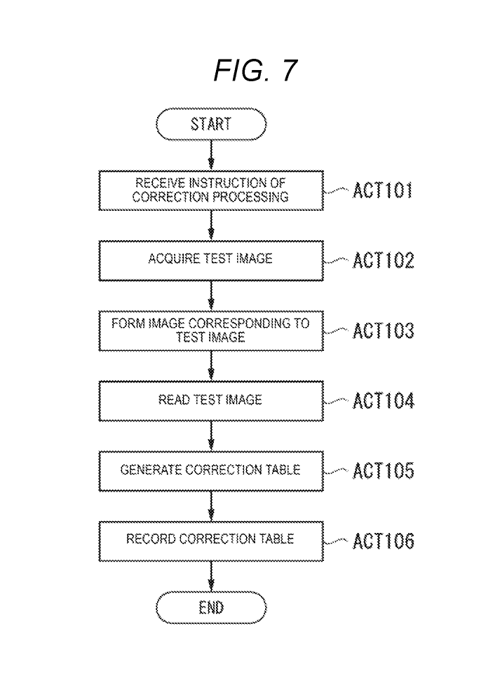

FIG. 7 is a flowchart of processing of the image forming apparatus according to the embodiment. The control panel 120 receives an instruction of gamma correction processing from a user (ACT 101). The control panel 120 outputs information regarding the instruction of the gamma correction processing to the test image generation unit 151. The test image generation unit 151 acquires a test image from the test image storage unit 102 based on the information regarding the instruction of the gamma correction processing (ACT 102). The test image generation unit 151 outputs the test image to the printer unit 130. The printer unit 130 forms a printed image including the test image (ACT 103).

The image reading unit 200 reads the printed test image (ACT 104). The gamma-correction table generation unit 152 generates a gamma correction table based on image data read from the printed test image (ACT 105). The gamma-correction table generation unit 152 stores the gamma correction table in the gamma-correction table storage unit 103 (ACT 106). The gamma-correction table generation unit 152 may also store the gamma correction table in the gamma correction processing unit 156 instead of storing the gamma correction table in the gamma-correction table storage unit 103.

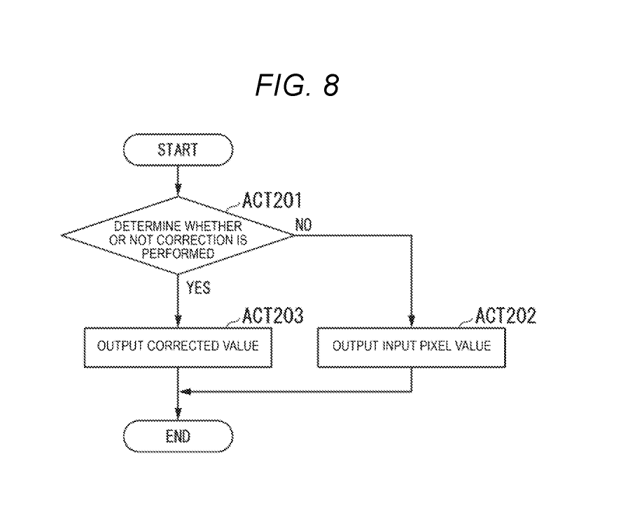

FIG. 8 is a flowchart illustrating a flow of gamma correction processing of the image forming apparatus according to the embodiment. The gamma correction processing unit 156 determines whether or not value of a target pixel in image data as read has a value other than 255, which is the maximum possible value. In addition, the gamma correction processing unit 156 determines whether or not the target pixel represents an edge based on edge information (ACT 201). When the target pixel is not solid (that is, the read density does not have the maximum value), or when the target pixel is solid (that is, the read density has the maximum value) but does not represent an edge (YES in ACT 201), the gamma correction processing unit 156 sets the output value to a value obtained by performing the gamma correction processing on the input value (ACT 202). That is, when the target pixel is not solid or when the target pixel is solid but does not represent an edge, the gamma correction processing unit 156 performs gamma correction. When the target pixel is solid (that is, the read density has the maximum value) and also represents an edge (NO in ACT 201), the gamma correction processing unit 156 simply outputs the input value as the output value (ACT 203). That is, when the target pixel is solid and represents an edge, the gamma correction processing unit 156 does not perform the gamma correction.

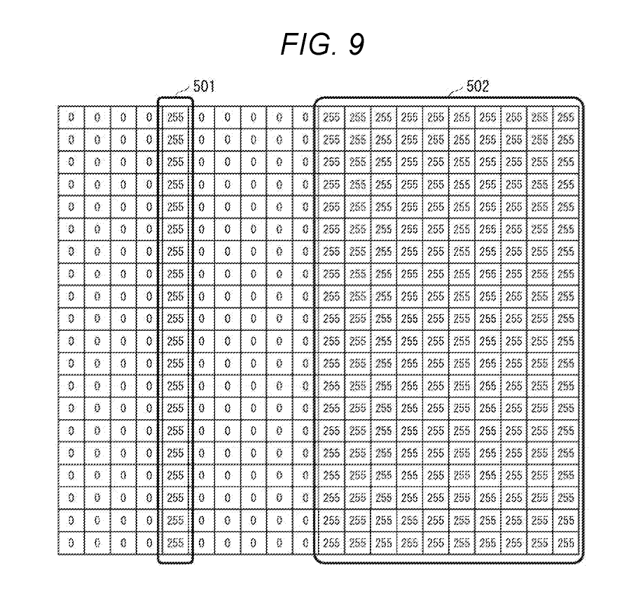

FIG. 9 is a diagram illustrating an example of an input image before the gamma correction processing. The image data in FIG. 9 includes graphics. A region 501 represents a thin line with a width corresponding to one pixel. A region 502 represents an image area.

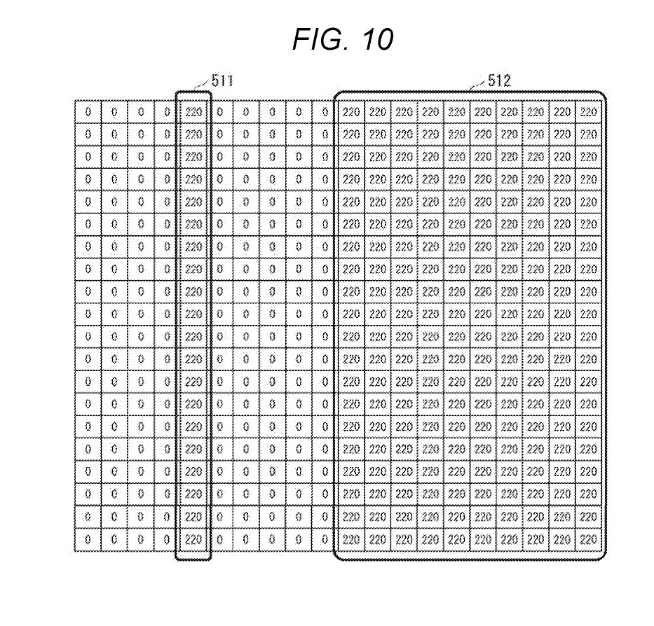

FIG. 10 is a diagram illustrating an example of a result after the gamma correction processing. FIG. 10 illustrates a result when a gamma correction table associating an input value of 255 to an output value of 220 is applied. A region 511 represents a thin line. A region 512 represents an image area. Since all input values in the region 511 and the region 512 are 255, all output values are corrected to be 220.

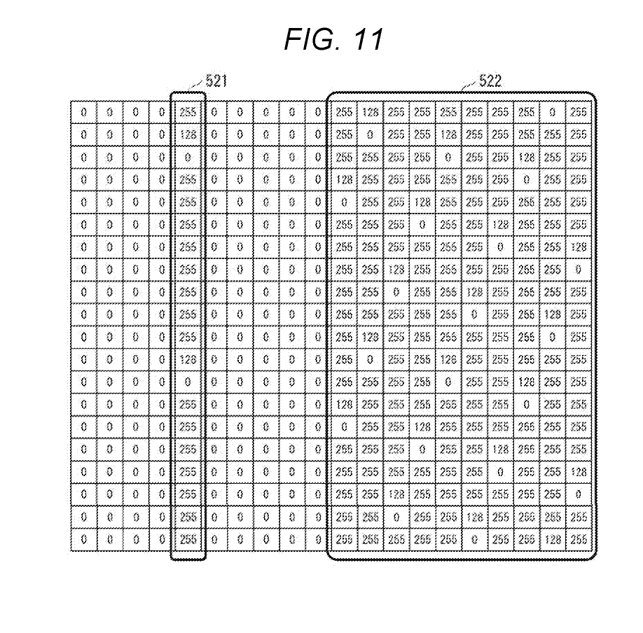

FIG. 11 is a diagram illustrating an example of a result after halftone processing in the related art is performed. A region 521 represents a thin line. A region 522 represents an image area. An output value is decreased by the gamma correction, and thus screening is applied to the thin line. Thus, when this halftone processing is performed, deterioration of image quality, for example, interruption of the thin line occurs.

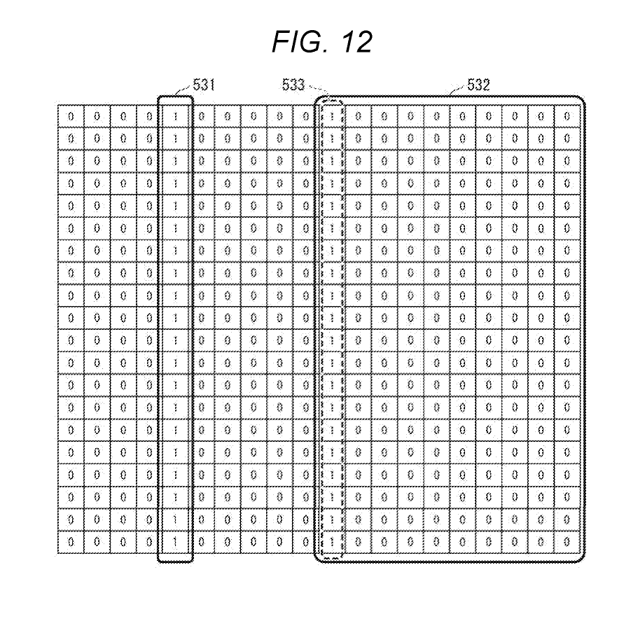

FIG. 12 is a diagram illustrating an example of the edge information according to the embodiment. A region 531 represents a portion of a thin line. A region 532 represents an image area. A region 533 represents an edge portion of the image area (region 533 is a sub-portion of region 532).

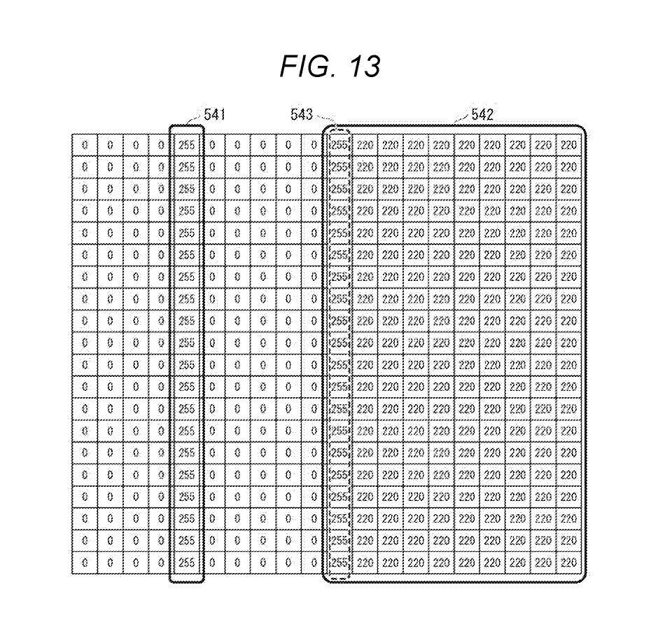

FIG. 13 is a diagram illustrating an example of a result after the gamma correction processing based on the edge information according to the embodiment. A region 541 represents a thin line. A region 542 represents an image area. A region 543 represents an edge portion of the image area. In the embodiment, since pixels in the region 543 are edge pixels, the original pixel values (i.e., 255) are maintained.

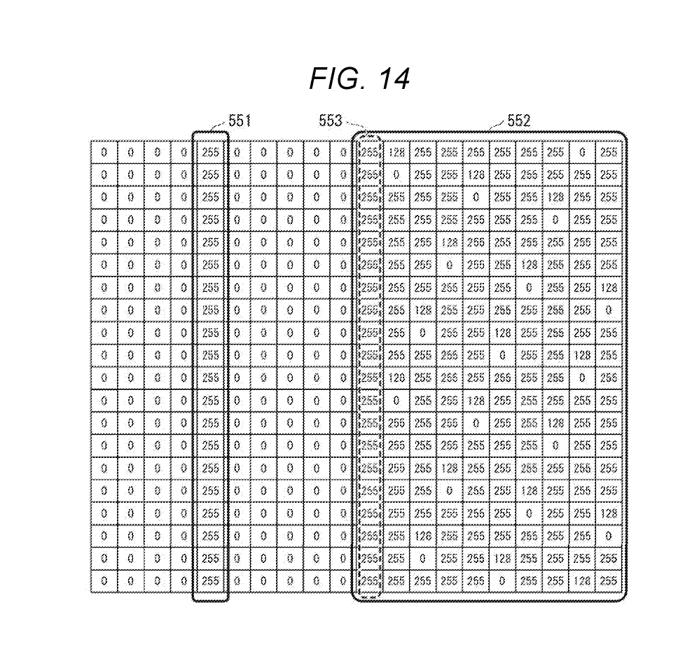

FIG. 14 is a diagram illustrating an example of a result after the halftone processing according to the embodiment. A region 551 represents a thin line. A region 552 represents an image area. A region 553 represents an edge portion of the image area represented by region 552. In the embodiment, since pixels in the region 551 representing the thin line and in region 553 representing the edge portion of the image area (region 552) are edge pixels, correction processing for unevenness is not performed. Therefore, pixel values of the pixels in the region 551 and in the region 553 are maintained at the original pixel values, and disruption of the thin line (region 551) does not occur.

With such a configuration, the gamma correction processing unit 156 does not perform the gamma correction on edge pixels and only performs the gamma correction on non-edge pixels. Thus, the gamma correction processing unit 156 still provides the desired print density by performing correction of solid density on non-edge pixels. The gamma correction processing unit 156 can prevent deterioration of image quality by not performing correction on edge pixels and can still perform correction processing suitable for image data in non-edge regions. Accordingly, it is possible to improve image quality, because solid density in non-edge regions has been corrected by the gamma control.

According to at least one embodiment, it is possible to improve image quality, because the solid density has been corrected by gamma control via operations of the gamma correction processing unit 156.

The edge determination unit 155 in the embodiment is an example of an edge information generation unit.

The gamma correction processing unit 156 according to the embodiment is an example of the correction determination unit and the correction processing unit. A case where the gamma correction processing unit 156 integrates correction determination unit and the correction processing unit has been described as an example. However, the correction determination unit and the correction processing unit may also be separately provided in the image forming apparatus 100.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming apparatus, comprising:
a printer configured to form an image on a sheet according to image data supplied to the printer;
a first storage device that stores image data of a predetermined test pattern image;
an image reading unit configured to read the image formed on the sheet;
a second storage device that stores a gamma correction table, the gamma correction table specifying a maximum output density of the printer, the maximum output density being determined according to a maximum read density that has been read from a sheet on which the predetermined test pattern image has been formed by the printer; and
a controller configured to apply a gamma correction to a pixel of the image data in accordance with the gamma correction table according to whether or not the pixel represents an edge portion of the image.

2. The image forming apparatus according to claim 1, wherein the gamma correction table maps read density of the pixel to a predetermined output density.

3. The image forming apparatus according to claim 2, wherein the predetermined output density of the pixel has a value smaller than the read density of the pixel.

4. The image forming apparatus according to claim 1, wherein when read density of the pixel is the maximum read density and the pixel represents the edge portion, the controller is further configured to not apply the gamma correction to the pixel.

5. The image forming apparatus according to claim 1, wherein when read density of the pixel is the maximum read density and the pixel does not represent the edge portion, the controller is further configured to apply the gamma correction to the pixel.

6. The image forming apparatus according to claim 1, wherein when read density of the pixel is not the maximum read density, the controller is further configured to apply the gamma correction to the pixel.

7. The image forming apparatus according to claim 1, wherein the controller is further configured to set an output density of the pixel.

8. The image forming apparatus according to claim 1, wherein the controller is further configured to generate the gamma correction table according to the maximum read density that has been read from the predetermined test pattern image by the image reading unit.

9. The image forming apparatus according to claim 1, wherein the controller is further configured to detect whether or not a pixel of the image represents an edge portion of the image.

10. An image forming method, comprising:
storing image data of a predetermined test pattern image in a storage device;
with a printer, forming a first image on a sheet according to the image data of the predetermined test pattern image;
with an image reading unit, reading the first image formed on the sheet;
generating a gamma correction table specifying a maximum output density for forming a second image on a sheet, the maximum output density being set according to a maximum read density that has been read from the first image by the image reading unit; and
applying a gamma correction to a pixel of image data of the second image in accordance with the gamma correction table according to whether or not the pixel of the image data of the second image represents an edge portion in the second image.

11. The method according to claim 10, wherein the gamma correction table maps read density of the pixel to a predetermined output density of the pixel.

12. The method according to claim 10, further comprising:
when read density of the pixel is the maximum read density and the pixel represents the edge portion, not applying the gamma correction to the pixel;
when read density of the pixel is the maximum read density and the pixel does not represent the edge portion, applying the gamma correction to the pixel; and
when read density of the pixel is not the maximum read density, applying the gamma correction to the pixel.

13. The method according to claim 10, further comprising:
setting an output density of the pixel.

14. The method according to claim 10, further comprising:
detecting whether or not a pixel of the second image represents an edge portion of the image.

15. An image forming apparatus comprising:
a printer configured to form an image on a sheet according to image data supplied to the printer;
a first storage device that stores image data of a predetermined test pattern image;
an image reading unit configured to read the image formed on the sheet;
a second storage device that stores a gamma correction table specifying a maximum output density of the printer, the maximum output density being determined according to a maximum read density that has been read from a sheet on which the predetermined test pattern image has been formed by the printer; and
a controller configured to
detect whether or not a pixel of the image represents an edge portion of the image; and
apply a gamma correction to a pixel of the image data or not in accordance with the gamma correction table according to whether or not the pixel represents an edge portion of the image.

16. The apparatus according to claim 15, wherein the gamma correction table maps read density of the pixel to a predetermined output density.

17. The apparatus according to claim 16, wherein the predetermined output density of the pixel has a value smaller than the read density of the pixel.

18. The apparatus according to claim 15, wherein
when read density of the pixel is the maximum read density and the pixel represents the edge portion, the controller is further configured to not apply the gamma correction to the pixel,
when read density of the pixel is the maximum read density and the pixel does not represent the edge portion, the controller is further configured to apply the gamma correction to the pixel, and
when read density of the pixel is not the maximum read density, the controller is further configured to apply the gamma correction to the pixel.

19. The apparatus according to claim 15, wherein the controller is further configured to set an output density of the pixel.

20. The apparatus according to claim 15, wherein
the controller is further configured to generate the gamma correction table according to the maximum read density that has been read from the predetermined test pattern image by the image reading unit.
